(19) United States
(12) Patent Application Publication
(10) Pub. No.: US 2007/0098315 A1
(43) Pub. Date: May 3, 2007

(54) Bearing apparatus for a wheel of vehicle

(75) Inventors: Kazuo Komori, IWATA-SHI (JP); Kazuhiro Baba, Shizuoka-ken (JP)

Correspondence Address: HARNESS, DICKEY & PIERCE, P.L.C., P.O. BOX 828, BLOOMFIELD HILLS, MI, 48303, US

(73) Assignee: NTN CORPORATION, OSAKA (JP)

(21) Appl. No.: 10/580,721

(22) PCT Filed: Nov. 6, 2004
(86) PCT No.: PCT/JP04/17025

§ 371 Date: Aug. 8, 2006

(30) Foreign Application Priority Data
Nov. 28, 2003 (JP) 2003-399127
Jun. 2, 2004 (JP) 2004-164246

(51) Int. Cl. F16C 13/00

(52) U.S. Cl. 384/544

(57) ABSTRACT

A vehicle wheel bearing apparatus which can be press-fit into a knuckle of a light metal alloy, which is intended to reduce its weight as well as to prevent the reduction of preload and generation of creep in the wheel bearing due to temperature rise, has a wheel hub (1) with an integrally formed wheel mounting flange (4) at one end and an axially extending cylindrical portion (5) of a smaller diameter. A wheel bearing (3, 20, 24, 29, 31, 36, 37, 40, 43), including a double row rolling bearing, is arranged on the cylindrical portion (5). A knuckle (2) of a light metal includes the wheel bearing (3, 20, 24, 29, 31, 36, 37, 40, 43) press-fit into the knuckle (2) via a predetermined interference. The wheel hub (1) is rotatably supported relative to the knuckle (2) via the wheel bearing (3, 20, 24, 29, 31, 36, 37, 40, 43). At least one of an inner circumferential surface of an inner ring (13, 26, 33, 39, 44) and an outer circumferential surface of an outer ring (12, 21, 25, 30, 32, 38) of the wheel bearing (3, 20, 24, 29, 31, 36, 37, 40, 43) is formed with at least one annular groove (18, 22, 34, 45). Each annular groove (18, 22, 34, 45) is filled with a resin band (19, 23, 35, 46) by injection molding a heat resisting synthetic resin.

### CROSS-REFERENCE TO RELATED APPLICATIONS

This application is a National Stage of International Application No. PCT/JP2004/017025, filed Nov. 6, 2004, which claims priority to Japanese Patent Application Nos. 2003˜399127, filed Nov. 28, 2003 and 2004˜164246, filed Jun. 2, 2004. The disclosures of the above applications are incorporated herein by reference.

### FIELD

The present invention relates to a vehicle wheel bearing apparatus and, more particularly, to improvements in mounting structures of a wheel bearing.

### BACKGROUND

A vehicle wheel bearing apparatus 80 of the prior art comprises, as shown in FIG. 14, a wheel hub 81 to secure a brake rotor 87 and a wheel (not shown). A wheel bearing 84 includes an outer ring 82 and a pair of inner rings 83 to rotatably support the wheel hub 81. A knuckle 85 supports the wheel bearing 84 on a body of the vehicle. A constant velocity universal joint 86, adapted to be connected to the wheel hub 81, transmits the power from a drive shaft (not shown) to the wheel hub 81.

Although ferrous metal, such as malleable cast iron having substantially the same coefficient of linear thermal expansion as material forming the wheel hub 81 etc., has been used to form parts such as the bearing apparatus 80 and especially the knuckle 85, it is a recent tendency to adopt a light metal alloy, such as aluminum alloy, in place of the ferrous metal to reduce the weight of the vehicle. However, a problem exists with the outer ring 82 of the wheel bearing 84. The outer ring 82 may release from the knuckle 85 due to a reduction of force in the interference fit caused by a temperature rise during travel of the vehicle. This is due to the difference of the coefficient of linear thermal expansion between the knuckle 85 and the outer ring 82, if the knuckle 85 is made from such a light metal alloy. As a result, trouble may exist such as a loss of preload. Thus, the preload of the wheel bearing set at its assembly cannot be maintained.

In addition, other problems may exist such as the generation of creep or seizing of the outer ring 82. These problems cause a reduction in the life of the wheel bearing. Creep in the outer ring 82 is a phenomenon where the interference fitting surface of the outer ring 82 is mirror finished by circumferential micro-movement of the outer ring 82 due to lack of an interference fitting force or finishing accuracy of the outer ring 82 which would cause seizing or melting of the outer ring 82.

In order to avoid these problems, it has been carried out, in the bearing apparatus 80 of the prior art, that the initial value of preload is set high to ensure the preload of the wheel bearing 84 in case of a temperature rise. Also, the initial interference is set large in anticipation of a reduction of the interference in case of a temperature rise to prevent creep. Since these prior art elements are carried out in practice, and to the best of Applicants' knowledge are not disclosed in any document, no prior art disclosure exists in any document.

### SUMMARY

However, if the initial amount of preload of the wheel bearing 84 is set high, the wheel bearing is always obliged to be excessively loaded and thus its life is reduced. In addition, the rigidity of the bearing is varied by a large variation of the amount of preload due to temperature variation. This causes an adverse influence on the running stability of the vehicle. Furthermore, if the initial interference is set large, it is necessary to press-fit the wheel bearing 84 by preheating the knuckle 85 to prevent the generation of galling in the knuckle 85 during press-fitting of the wheel bearing 84. This increases the assembling steps and thus manufacturing cost.

It is, therefore, an object of the present disclosure to provide a vehicle wheel bearing apparatus which can be press-fit into a light metal alloy knuckle intended to reduce its weight as well as to prevent the reduction of preload and generation of creep in the wheel bearing due to temperature rise.

To achieve the objects of the present disclosure, a vehicle wheel bearing apparatus comprises a wheel hub with an integrally formed wheel mounting flange at one end and an axially extending cylindrical portion of a smaller diameter. A wheel bearing, including a double row rolling bearing, is arranged on the cylindrical portion. A knuckle of light metal includes the wheel bearing press-fit into the knuckle via a predetermined interference. The wheel hub is rotatably supported relative to the knuckle via the wheel bearing. At least one of an inner circumferential surface of an inner ring and an outer circumferential surface of an outer ring of the wheel bearing is formed with an annular groove (or grooves). Each annular groove is filled with a resin band of heat resistance synthetic resin formed by injection molding.

Since at least one of the inner circumferential surface of the inner ring and/or the outer circumferential surface of the outer ring of the wheel bearing is formed with an annular groove (or grooves) and each annular groove is filled with a resin band of injection molded heat resisting synthetic resin, it is possible to suppress the reduction of fitting interference. Also, it is possible to prevent the generation of creep as well as a reduction of the initially set preload. Further, it is possible to securely keep the running stability of the vehicle by suppressing the variation of rigidity of the bearing.

Each resin band is made of synthetic resin from the polyamide family with a coefficient of linear thermal expansion of (8˜16)×10⁻⁵/° C. Since the resin band has a coefficient of linear thermal expansion larger than that of the knuckle, the resin band can follow the variation of thermal expansion of the knuckle even though the knuckle is thermally expanded larger than the outer ring of the wheel bearing.

Each resin band is formed so that it projects from the circumferential surface of the inner and/or outer rings. Thus, it is possible to prevent the reduction of the interference due to temperature rise. Also, it is possible to suppress the reduction of the rigidity of the resin band and, thus, to prevent breakage of the resin band during press-fitting.

Each annular groove is formed in a load supporting region of the inner or outer ring. This enables to effectively prevent the loss of preload and the generation of creep in the bearing.

Each annular groove is formed as an eccentric groove. The center of each groove is offset a predetermined amount from the central axis of the wheel bearing. This enables a simple structure to prevent the relative rotation between the resin band and the inner or outer ring.

The wheel bearing is secured with the wheel hub, while being sandwiched between the wheel hub and a shoulder of an outer joint member forming a part of a constant velocity universal joint, via disc shaped expansion compensating members made of heat resisting synthetic resin. A predetermined preload is applied to the wheel bearing. Thus, it is possible to keep the initial preload of the bearing within a predetermined range for a long term without any change of the specification of the bearing apparatus of the prior art.

An annular groove is formed on each end face of a larger diameter of the inner ring. The annular groove is filled with the expansion compensating member by injection molding. Thus, it is possible to prevent the reduction of the initially set preload of the bearing and to improve the bearing assembling efficiency.

The vehicle wheel bearing apparatus of the present disclosure comprises a wheel hub with an integrally formed wheel mounting flange at one end and an axially extending cylindrical portion of a smaller diameter. A wheel bearing, including a double row rolling bearing, is arranged on the cylindrical portion. A knuckle of light metal includes the wheel bearing press-fit into the knuckle via a predetermined interference. The wheel hub is rotatably supported relative to the knuckle, via the wheel bearing. At least one of an inner circumferential surface of an inner ring and an outer circumferential surface of an outer ring of the wheel bearing is formed with an annular groove (or grooves). Each annular groove is filled with a resin band of injection molded heat resisting synthetic resin. Thus, it is possible to suppress the reduction of fitting interference, to prevent the generation of creep as well as reduction of the initially set preload. Also, it is possible to keep the running stability of the vehicle by suppressing the variation of rigidity of the bearing.

The bearing apparatus for a wheel of a vehicle comprises a wheel hub with an integrally formed wheel mounting flange at one end and an axially extending cylindrical portion of a smaller diameter. A wheel bearing, including a double row rolling bearing, is arranged on the cylindrical portion. A knuckle of light metal has the wheel bearing press-fit into the knuckle via a predetermined interference. The wheel hub is rotatably supported relative to the knuckle, via the wheel bearing. At least one of an inner circumferential surface of an inner ring and an outer circumferential surface of an outer ring of the wheel bearing is formed with an annular groove (or grooves). Each annular groove is filled with a resin band of injection molded heat resisting synthetic resin. Each resin band is made of synthetic resin from the polyamide family having a coefficient of linear thermal expansion of (8˜16)×10⁻⁵/° C.

Further areas of applicability will become apparent from the description provided herein. It should be understood that the description and specific examples are intended for purposes of illustration only and are not intended to limit the scope of the present disclosure.

### DRAWINGS

Additional advantages and features of the present disclosure will become apparent from the subsequent description and the appended claims, taken in conjunction with the accompanying drawings, wherein:

FIG. 1 is a longitudinal section view of a first embodiment of the bearing apparatus for a wheel of a vehicle;

FIG. 2 is a longitudinal section view of a wheel bearing used in the bearing apparatus of the first embodiment;

FIG. 3 is a graph showing a relationship between the temperature variation and the bearing preload as to wheel bearings of the prior art and the present disclosure;

FIG. 4 is a longitudinal-section view of a second embodiment of a bearing apparatus for a wheel of a vehicle;

FIG. 5 is a longitudinal section view of a third embodiment of a bearing apparatus for a wheel of a vehicle;

FIG. 6 is a longitudinal section view of a wheel bearing used in a bearing apparatus of a third embodiment;

FIG. 7 is a longitudinal section view of a wheel bearing used in a bearing apparatus of a fourth embodiment;

FIG. 8 is a longitudinal section view of a wheel bearing used in a bearing apparatus of a fifth embodiment;

FIG. 9 is a longitudinal section view of a wheel bearing used in a bearing apparatus of a sixth embodiment;

FIG. 10 is a longitudinal section view of a wheel bearing used in a bearing apparatus of a seventh embodiment;

FIG. 11 is a longitudinal section view of a wheel bearing used in a bearing apparatus of an eighth embodiment;

FIG. 12 is a longitudinal section view of a ninth embodiment of a bearing apparatus for a wheel of vehicle;

FIG. 13 is an enlarged longitudinal section view of a tenth embodiment of a bearing apparatus for a wheel of a vehicle; and

FIG. 14 is a longitudinal section view of a bearing apparatus for a wheel of a vehicle of the prior art.

### DETAILED DESCRIPTION

Preferable embodiments of the present disclosure will be hereinafter described with reference to the drawings.

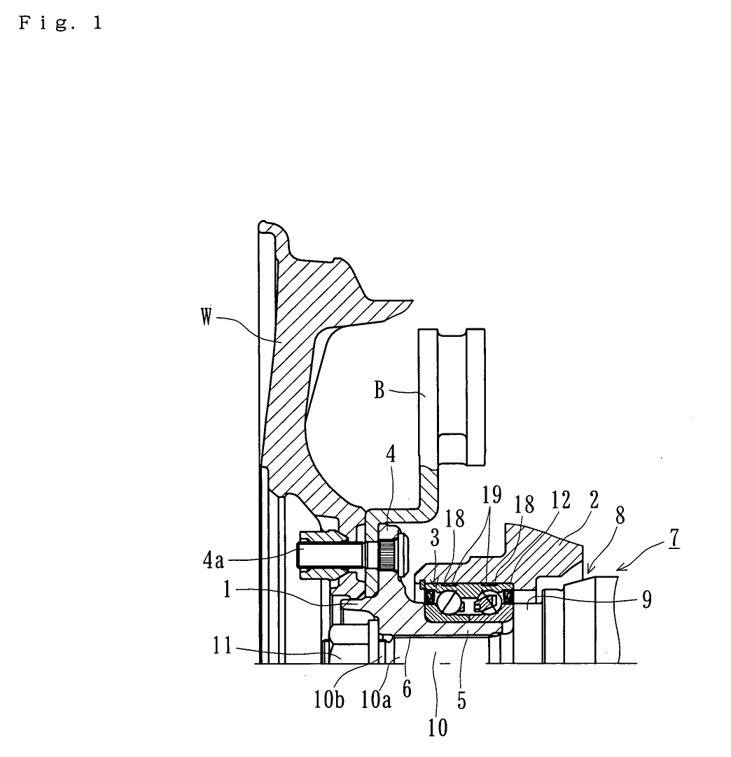

FIG. 1 shows a first embodiment of a bearing apparatus for a wheel of a vehicle of the present disclosure. In the description below, the term “outboard side” of the apparatus denotes a side which is positioned outside of the vehicle body. The term “inboard side” of the apparatus denotes a side which is positioned inside of the body when the bearing apparatus is mounted on the vehicle body.

The vehicle wheel bearing apparatus of the present disclosure shown in FIG. 1 comprises, as main components, a wheel hub 1 and a wheel bearing 3 rotatably supporting the wheel hub 1 relative to a knuckle 2. The wheel hub 1 is made of medium carbon steel which includes carbon of 0.40˜0.80% by weight, such as S53C. The wheel hub 1 has a wheel mounting flange 4 to mount a wheel “W” and a brake rotor “B” at an end of the outboard side. A cylindrical portion 5, of smaller diameter, axially extends from the wheel mounting flange 4. Hub bolts 4a, for securing the wheel “W” and the brake rotor “B”, are secured on the wheel mounting flange 4 at an equidistant interval along its circumferential direction. A serration (or spline) 6 is on an inner circumferential surface of the wheel hub 1. The wheel bearing 3 is press-fit onto the outer circumferential surface of the cylindrical portion 5.

The wheel bearing 3 is press-fit onto the cylindrical portion 5 of the wheel hub 1. The wheel bearing 3 is secured with and sandwiched between the wheel hub 1 and a shoulder 9 of an outer joint member 8, which forms a part of a constant velocity universal joint 7. The outer joint member 8 is integrally formed with a stem portion 10 which axially extends from the shoulder 9. A serration (or spline) 10a on the stem portion 10 engages the serration 6 of the wheel hub 1. A threaded portion 10b is formed on the outer circumferential surface of the stem 10. Thus, torque from an engine can be transmitted to the wheel hub 1, via a drive shaft (not shown), the constant velocity universal joint 7, and the serrated portions 6 and 10a.

The serration 10a is provided with a helix angle inclined at a predetermined angle relative to the central axis of the stem portion 10. Thus, the serrated portion 10a, with its helix angle, is press-fit into the serrated portion 6 of the wheel hub 1 until the shoulder 9 of the outer joint member 8 abuts the wheel bearing 3. Accordingly, a circumferential rattle between the serrated portions 6 and 10a are cancelled by applying the preload between the two. In addition, it is designed that a desirable bearing preload can be obtained by fastening a securing nut 11, with a predetermined fastening torque, onto the threaded portion 10b, formed on the end of the stem portion 10. Thus, the wheel bearing 3 is press-fit with a predetermined interference to prevent bearing creep on the bearing relative to the wheel hub 1 and to obtain a desired amount of preload. On the other hand, the knuckle 2 is formed of a light metal such as an aluminum alloy. Thus, the weight of the knuckle 2 can be reduced to half the weight of a knuckle made of cast iron although the thickness of the knuckle of light metal is increased to make up for any deficiency of its rigidity. The wheel bearing 3 is press-fit into the knuckle 2.

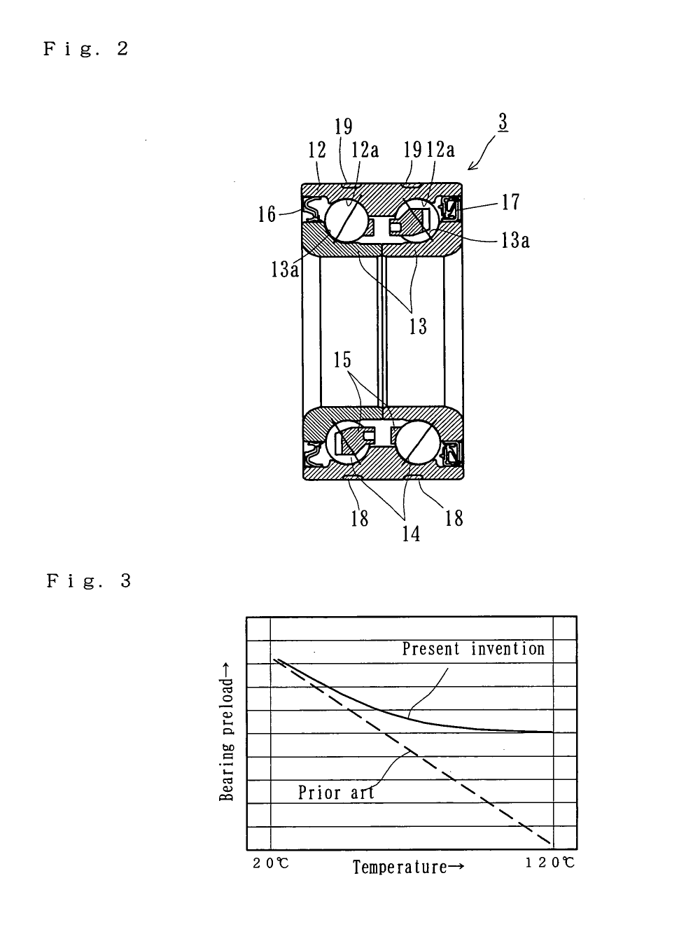

As shown in FIG. 2, the wheel bearing 3 is made of high carbon chrome bearing steel, such as SUJ2. The bearing 3 has an outer ring 12, one pair of inner rings 13, and a double row rolling elements (balls) 14. Double row outer raceway surfaces 12a are formed on the inner circumferential surface of the outer ring 12. An inner raceway surface 13a is formed on each outer circumferential surface of each inner ring 13. The inner raceway surfaces 13a are arranged opposite to each of the outer raceway surface 12a. The double row rolling elements (balls) 14 are rollably contained by cages 15 between the outer and inner raceway surfaces 12a and 13a. Seals 16 and 17 are arranged at either ends of the wheel bearing 3. The seals 16, 17 prevent grease contained within the bearing 3 from leaking out therefrom as well as rain water and dusts from entering into the bearing 3.

A pair of annular grooves 18 is formed on the outer circumferential surface of the outer ring 12. These annular grooves 18 are arranged at positions corresponding to the bottoms of the outer raceway surfaces 12a or close to the bottoms, which is a load supporting area. Thus, the loss of preload and the bearing creep can be effectively prevented. Each of the annular grooves 18 is filled with a resin band 19. The resin band 19 is formed by injection molding PA 11 (polyamidel 11) based heat resisting thermoplastic synthetic resin into the grooves. The outer diameter of the resin band 19 projects from the outer ring 12 by 0˜50 μm. It is difficult to prevent the reduction of interference due to temperature rise if the projected amount is less than 0. On the other hand, damage, such as gouges, tend to be caused on the resin band 19 during press-fitting into the knuckle 2 if the projected amount exceeds 50 μm. Although the projected amount is determined based on the size of the bearing, it is preferable to set the projected amount within a range of about 10˜40 μm in consideration of dispersion of manufacture.

The material of the resin band 19 is not limited to PA 11. Any synthetic resin may be used if it has a coefficient of linear thermal expansion ((8˜16)×10⁻⁵/° C.) larger than that ((2˜2.3)×10⁻⁵/° C.) of the knuckle 2 of light metal, such as aluminum alloy. Examples of the resin band 19 include PA66 and composite material of thermoplastic resin and reinforcing fibers such as GF (glass fibers) contained therein within a range of 10˜30% by weight. Preferably, each annular groove 18 is formed as an eccentric groove where the center is offset a predetermined amount from the central axis of the wheel bearing 3 in order to prevent the resin band 10 from rotating relative to the outer ring 12.

FIG. 3 is a graph showing a relation between the temperature variation and the bearing preload. The temperature variation and dimensional variation of the outer raceway surfaces 12a of the outer ring 12 is measured under a condition where only the outer ring of the wheel bearings of the prior art and the present disclosure are press-fit into the knuckle of aluminum alloy. It will be appreciated from this graph that although the bearing preload is linearly reduced corresponding to the temperature rise in the outer ring of the prior art, the bearing preload in the outer ring of the present disclosure is more gradually reduced than that of the prior art toward a temperature of about 80° C. and thereafter a predetermined amount of preload can be maintained.

As described above, according to the present disclosure, since the knuckle 2 is formed of a light metal such as aluminum alloy and resin bands 19, with a coefficient of linear thermal expansion larger than that of the knuckle 2 are formed on the outer circumferential surface of the outer ring 12 of the wheel bearing 3 press-fit into the knuckle 2, it is possible to suppress the reduction of the fitting interference. Also, it is possible to prevent the generation of the bearing creep. Further, it is possible to keep the running stability of the vehicle, with suppressing the variation of bearing rigidity, although the knuckle 2 would be thermally expanded larger than the outer ring itself of the wheel bearing 3 during temperature rise.

In addition it is possible, by applying the present disclosure to a wheel bearing apparatus of a first generation type, to keep characteristic features such as standardization and general utility of bearings, etc., to improve the running stability of the vehicle, with suppressing the variation of bearing rigidity, even if the bearing has relatively small rigidity. Also, it is possible to keep the initial bearing preload at a predetermined range for a long term without changing the specifications of the wheel bearing apparatus of the prior art.

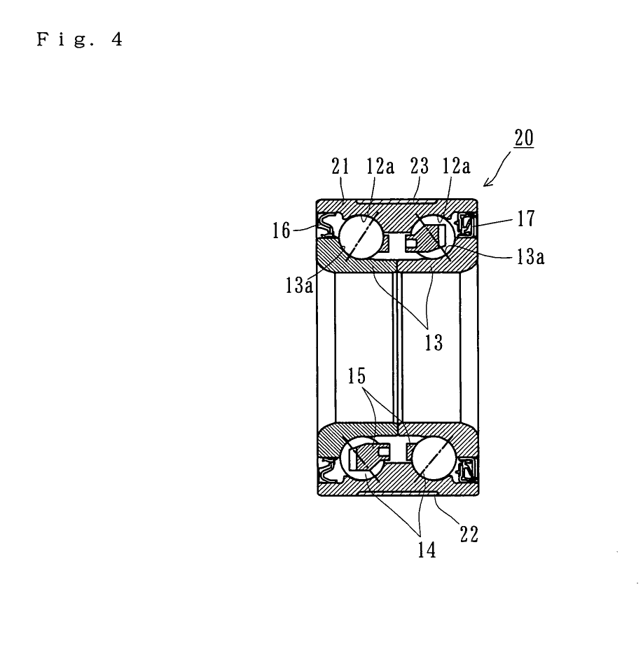

FIG. 4 is a longitudinal view of a second embodiment of a bearing apparatus for a wheel. This embodiment is different from the first embodiment only in the structure of the outer ring. Thus, the same reference numerals are used to designate the same parts having the same functions used in the first embodiment.

In this wheel bearing 20, a single annular groove 22 is formed on the outer circumferential surface of the outer ring 21. The annular groove 22 is formed at the axially center of the outer circumferential surface of the outer ring 21. Thus, the annular groove 22 spans the double row outer raceway surfaces 12a. The annular groove 22 is filled with a resin band 23. The resin band 23 is formed by injection molding PA 11 (polyamidel 1), a heat resisting thermoplastic synthetic resin.

Since the resin band 23 of the second embodiment is formed by the same manner as that of the first embodiment, it is possible to suppress the reduction of the fitting interference. Also, it is possible to prevent the generation of bearing creep. Further, it is possible to keep the running stability of vehicle, with suppressing the variation of bearing rigidity, although the knuckle 2 would be thermally expanded larger than the outer ring itself of the wheel bearing 20 during temperature rise.

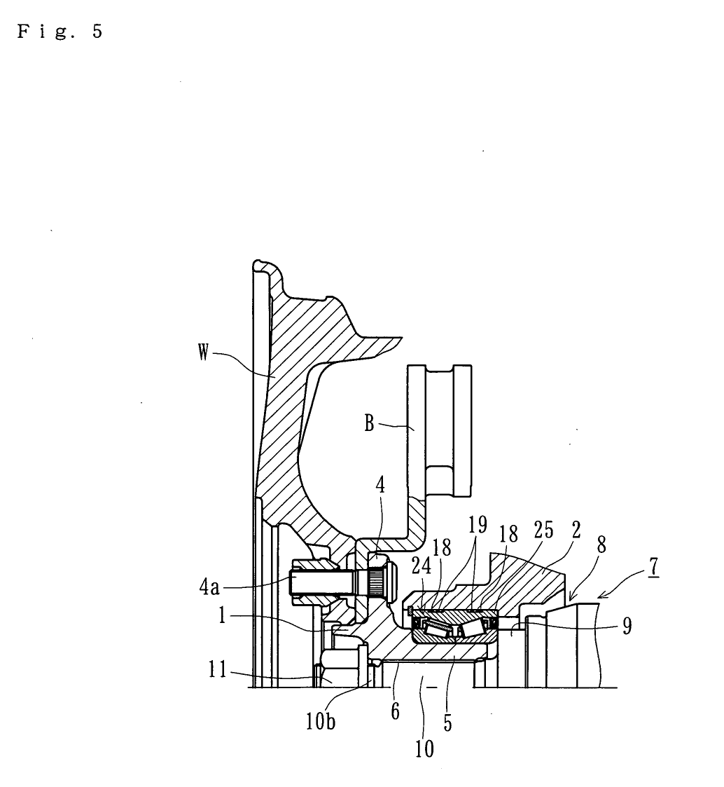

FIG. 5 is a longitudinal view of a third embodiment of a bearing apparatus for a wheel. This embodiment is different from the first embodiment only in the structure of the wheel bearing. Thus, the same reference numerals are used to designate the same parts having the same functions used in the first embodiment.

In this vehicle wheel bearing apparatus, the wheel bearing 24 is press-fit onto the cylindrical portion 5 of the wheel hub 1. The wheel bearing 24 is secured on the wheel hub 1 and sandwiched between the wheel hub 1 and a shoulder 9 of an outer joint member 8. A desirable bearing preload can be obtained by fastening the securing nut 11, with a predetermined fastening torque, onto the threaded portion 10b formed on the end of the stem portion 10. The wheel bearing 24 is press-fit with a predetermined interference into the knuckle 2, formed of a light metal such as aluminum alloy.

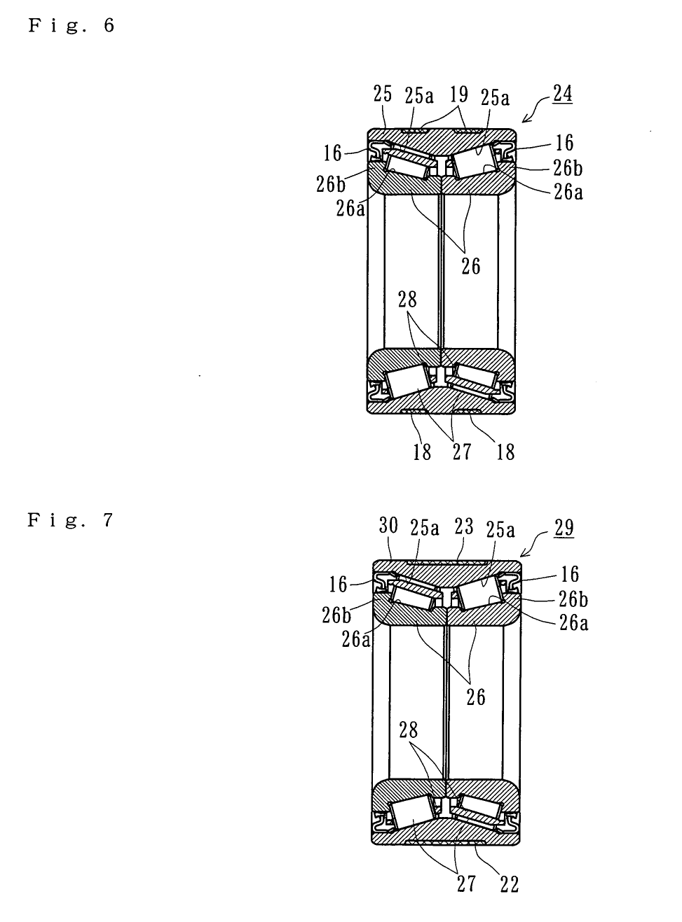

As shown in FIG. 6, the wheel bearing 24 has an outer ring 25, one pair of inner rings 26, and a double row rolling elements (conical rollers) 27. Double row outer raceway surfaces 25a are formed on the inner circumferential surface of the outer ring 25. An inner raceway surface 26a is formed on each outer circumferential surface of each inner ring 26. The inner raceway surfaces 26a are arranged opposite to each of the outer raceway surfaces 25a. The double row rolling elements 27 are rollably contained by cages 28 between the outer and inner raceway surfaces 25a and 26a. The rolling elements 27 are guided by larger flanges 26b. Seals 16 are arranged at either ends of the wheel bearing 24 to prevent grease, contained within the bearing 24, from leaking out as well as rain water and dusts from entering into the bearing 24.

A pair of annular grooves 18 is formed on the outer circumferential surface of the outer ring 25. The annular grooves 18 are arranged at load supporting areas of the double row outer raceway surfaces 25a. Each of the annular grooves 18 is filled with a resin band 19. The resin band 19 is formed by injection molding PA 11 (polyamidel 1) based heat resisting thermoplastic synthetic resin.

In the wheel bearing 24, including the double row conical rollers, the rolling elements (conical rollers) 27 contact the inner and outer raceway surfaces 26a and 25a in a line contact manner. Thus, a larger load supporting capacity can be obtained as compared with the previously mentioned double row angular ball bearing. On the contrary, since a large amount of preload is required to be applied to the bearing, it is known that the temperature rise of the bearing is increased and thus its life is reduced. In addition, it is difficult to set the initial amount of preload since premature peeling would be caused with the introduction of edge load if the amount of the preload is reduced.

In the wheel bearing 24, including the double row conical rollers of this third embodiment, since it is possible to suppress the reduction of the fitting interference; to prevent the generation of the bearing creep; and to keep the running stability of the vehicle, with suppressing the variation of bearing rigidity, although the knuckle 2 would be thermally expanded larger than the outer ring itself of the wheel bearing 24 during temperature rise, it is unnecessary to set a large bearing preload and interference and thus an excellent effect can be obtained in the improvement of the bearing life.

FIG. 7 is a longitudinal view of a fourth embodiment of a bearing apparatus for a wheel. This embodiment is different from the first embodiment only in the structure of the outer ring. Thus, the same reference numerals are used to designate the same parts having the same functions used in the third embodiment.

In this wheel bearing 29, a single annular groove 22 is formed on the outer circumferential surface of the outer ring 30. The annular groove 22 is formed at the axial center of the outer circumferential surface of the outer ring 30. Thus, the annular groove 22 spans the double row outer raceway surfaces 25a. The annular groove 22 is filled with the resin band 23, which is formed by injection molding PA 11 (polyamidel 1) based heat resisting thermoplastic synthetic resin.

Since the resin band 23 of this second embodiment is formed in the same manner as that of the first embodiment, it is also possible to suppress the reduction of the fitting interference; to prevent the generation of the bearing creep; and to keep the running stability of vehicle, with suppressing the variation of bearing rigidity, although the knuckle 2 would be thermally expanded larger than the outer ring itself of the wheel bearing 29 during temperature rise.

FIG. 8 is a longitudinal view of a fifth embodiment of a bearing apparatus for a wheel. The same reference numerals are used to designate the same parts having the same functions used in the previous embodiments.

The wheel bearing 31 comprises an outer ring 32, one pair of inner rings 33, and a double row rolling elements (balls) 14. A pair of annular grooves 34 are formed on the pair of the inner rings 33. These annular grooves 34 are arranged at positions corresponding to the bottoms of the inner raceway surfaces 13a or close to the bottoms, load supporting areas. Each of the annular grooves 34 is filled with a resin band 35 which is formed by injection molding PA 11 (polyamidel 1) based heat resisting thermoplastic synthetic resin.

Thus, since the knuckle (not shown) is formed of a light metal, such as aluminum alloy, and the resin bands 35, having a coefficient of linear thermal expansion larger than that of the knuckle are formed on the inner circumferential surface of the inner rings 33 of the wheel bearing 31 press-fit into the knuckle, it is possible to suppress the reduction of the fitting interference. Also, it is possible to prevent the generation of bearing creep. Further, it is possible to keep the running stability of the vehicle, with suppressing the variation of bearing rigidity, although the knuckle would be thermally expanded larger than the wheel bearing 31 during temperature rise.

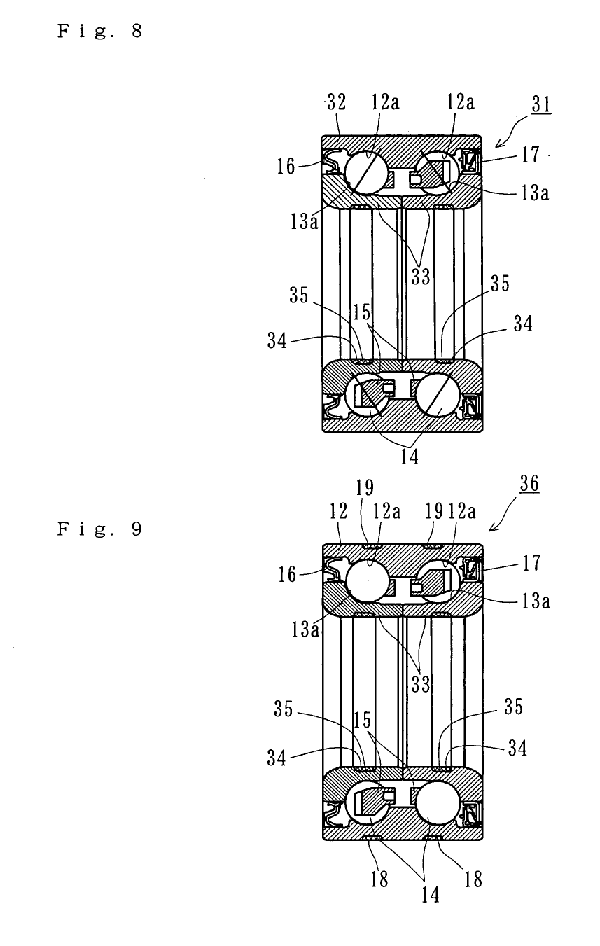

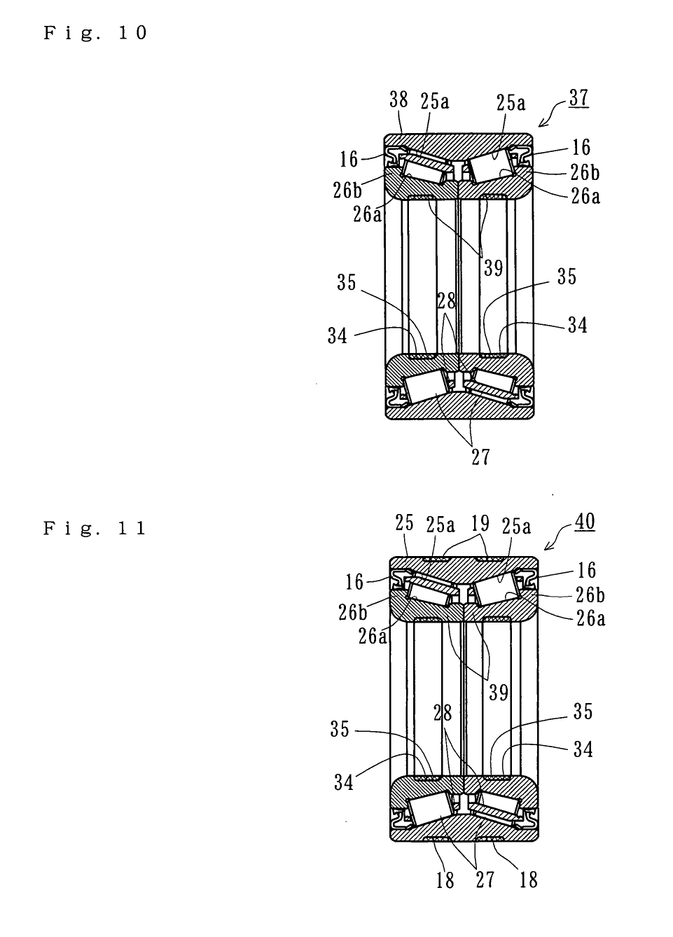

FIG. 9 is a longitudinal view of a sixth embodiment of a bearing apparatus for a wheel. The same reference numerals are used to designate the same parts having the same functions used in the previous embodiments.

The wheel bearing 36 comprises an outer ring 12, one pair of inner rings 33, and a double row rolling elements (balls) 14. Resin bands 35 and 19 are provided on the inner and outer circumferential surfaces of the inner rings 33 and the outer ring 12. Accordingly, since the resin bands 35 and 19 have a coefficient of linear thermal expansion larger than that of the knuckle, it is possible to suppress the reduction of the fitting interference; to prevent the generation of bearing creep; and to keep the running stability of the vehicle, with suppressing the variation of bearing rigidity, although the knuckle would be thermally expanded larger than the wheel bearing 36 during temperature rise.

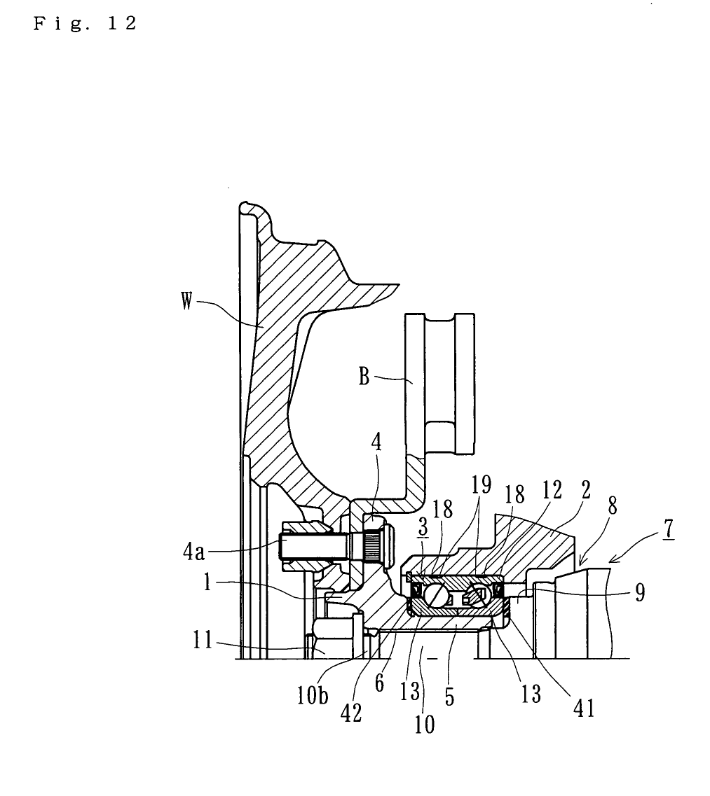

FIG. 10 is a longitudinal view of a seventh embodiment of a bearing apparatus for a wheel. This embodiment is different from the fifth embodiment (FIG. 8) only in the bearing structure. Thus, the same reference numerals are used to designate the same parts having the same functions used in the previous embodiments.

The wheel bearing 37 has an outer ring 38, one pair of inner rings 39, and a double row rolling elements (conical rollers) 34. Double row outer raceway surfaces 25a are formed on the inner circumferential surface of the outer ring 25. Annular grooves 34 are formed on the inner circumferential surface of the pair of inner rings 39. These annular grooves 34 are arranged at load supporting areas. Each of the annular grooves 34 is filled with a resin band 35, which is formed by injection molding PA 11 (polyamidel 1) based heat resisting thermoplastic synthetic resin.

Accordingly, since the knuckle (not shown) is formed of a light metal, such as aluminum alloy, and resin bands 35, having a coefficient of linear thermal expansion larger than that of the knuckle, are formed on the inner circumferential surface of the inner ring 39 of the wheel bearing 37 press-fit into the knuckle, it is possible to suppress the reduction of the fitting interference; to prevent the generation of the bearing creep; and to keep the running stability of vehicle, with suppressing the variation of bearing rigidity, although the knuckle would be thermally expanded larger than the wheel bearing 31 during temperature rise.

FIG. 11 is a longitudinal view of an eighth embodiment of a bearing apparatus for a wheel. This embodiment is different from the sixth embodiment (FIG. 9) only in the bearing structure. Thus, the same reference numerals are used to designate the same parts having the same functions used in the previous embodiments.

The wheel bearing 40 has an outer ring 25, one pair of inner rings 39, and a double row rolling elements (conical rollers) 27. Resin bands 35 and 19 are provided on the inner and outer circumferential surfaces of the inner rings 39 and the outer ring 25. Accordingly, since the resin bands 35 and 19 have a coefficient of linear thermal expansion larger than that of the knuckle, it is possible to suppress the reduction of the fitting interference; to prevent the generation of the bearing creep; and to keep the running stability of vehicle, with suppressing the variation of bearing rigidity, although the knuckle would be thermally expanded larger than the wheel bearing 40 during temperature rise.

FIG. 12 is a longitudinal view of a ninth embodiment of a bearing apparatus for a wheel. This embodiment is different from the first embodiment (FIG. 1) only in the structure for supporting the inner ring. Thus, the same reference numerals are used to designate the same parts having the same functions used in the first embodiment.

The wheel bearing 3 is press-fit onto the cylindrical portion 5 of the wheel hub 1. The wheel bearing 3 is secured with the inner rings 13 sandwiched, via expansion compensating members 41 and 42, between the wheel hub 1 and a shoulder 9 of an outer joint member 8, which forms a part of a constant velocity universal joint 7. The expansion compensating members 41 and 42 are formed from PA 11 (polyamide 11) based heat resisting thermoplastic synthetic resin. The members 41 and 42 have a coefficient of linear thermal expansion of ((8˜16)×10⁻⁵/° C.) which is larger than that of the wheel bearing 3, the wheel hub 1 and the outer joint member 8. Thus, similarly to the previous embodiments, due to difference in the coefficient of linear thermal expansion between the knuckle 2 and the wheel bearing 3, it is possible to suppress the reduction of the fitting interference; to prevent the generation of the bearing creep; and to keep the running stability of vehicle, with suppressing the variation of bearing rigidity, although the knuckle 2 would be thermally expanded larger than the wheel bearing 3 during temperature rise.

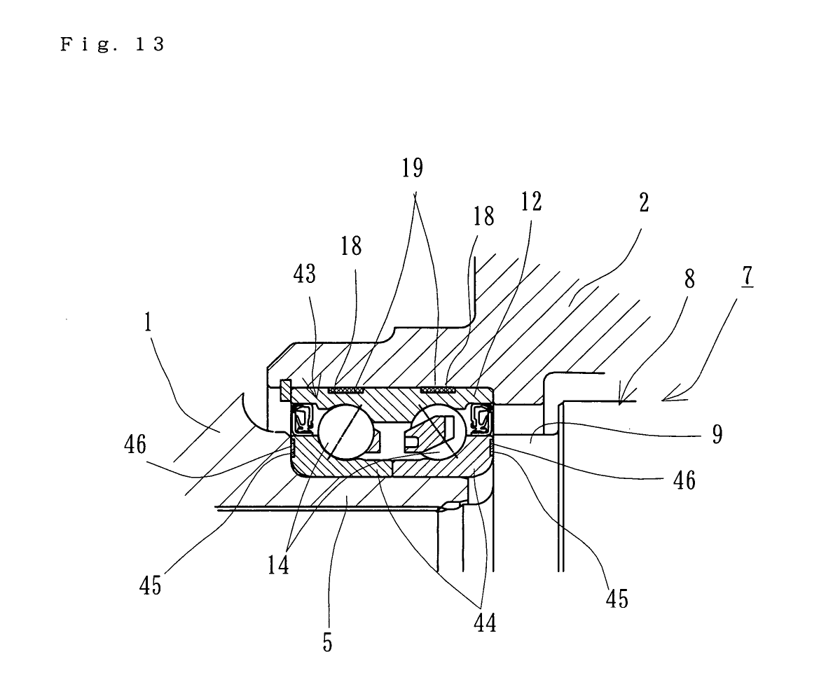

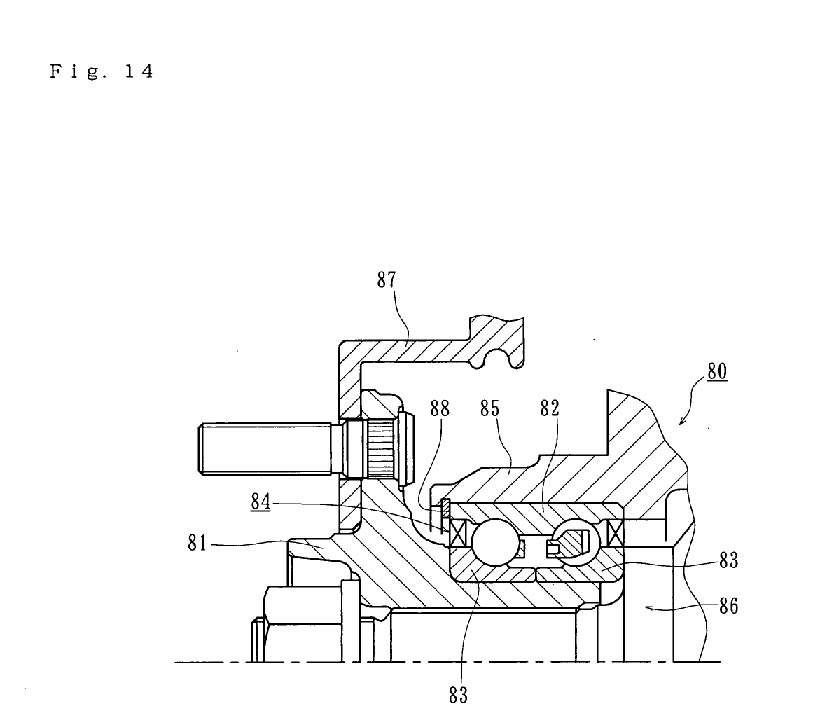

FIG. 13 is a longitudinal view of a tenth embodiment of a bearing apparatus for a wheel. This embodiment is different from the ninth embodiment (FIG. 12) only in the structure of the inner ring. Thus, the same reference numerals are used to designate the same parts having the same functions used in the ninth embodiment.

The wheel bearing 43 has an outer ring 12, one pair of inner rings 44, and a double row rolling elements (balls) 14. An annular groove 45 is formed on each end face of larger diameter of the inner rings. The annular groove 45 is filled with a resin band 46, which is formed by injection molding PA 11 (polyamidel 1) based heat resisting thermoplastic synthetic resin. Thus, similarly to the previous embodiments, it is possible to prevent reduction of the initially set bearing preload and to improve the assembling efficiency of the wheel bearing apparatus.

The vehicle wheel bearing apparatus can be applied to a structure where the knuckle, forming a suspension apparatus of a vehicle, is formed by a light metal such as aluminum alloy. The light metal has a coefficient of linear thermal expansion larger than that of steel.

The present disclosure has been described with reference to the preferred embodiments. Obviously, modifications and alternations will occur to those of ordinary skill in the art upon reading and understanding the preceding detailed description. It is intended that the present disclosure be construed as including all such alternations and modifications insofar as they come within the scope of the appended claims or their equivalents.

1-7. (canceled)

8. A vehicle bearing apparatus comprising:
a wheel hub having an integrally formed wheel mounting flange at one end and an axially extending cylindrical portion of a smaller diameter;
a wheel bearing including a double row rolling bearing being arranged on the cylindrical portion;
a knuckle of a light metal, said wheel bearing is press-fit into the knuckle via a predetermined interference, and said wheel hub being rotatably supported relative to the knuckle via the wheel bearing; and
at least one of an inner circumferential surface of an inner ring and an outer circumferential surface of an outer ring of the wheel bearing is formed with at least one annular groove and said at least one annular groove is filled with a resin band of heat resisting synthetic resin.

9. The bearing apparatus of claim 8 wherein said at least one resin band is made of synthetic resin from the polyamide family having a coefficient of linear thermal expansion of (8˜16)×10⁻⁵/° C.

10. The bearing apparatus of claim 8 wherein said at least one resin band is formed so that it projects from a circumferential surface of the inner and/or outer rings by 0˜50 μm.

11. The bearing apparatus of claim 8 wherein said at least one annular groove is formed in a load supporting region of the inner or outer ring.

12. The bearing apparatus of claim 8 wherein said at least one annular groove is formed as an eccentric groove, offset a predetermined amount from the central axis of the wheel bearing.

13. The bearing apparatus of claim 8 wherein the wheel bearing is secured with said wheel hub and sandwiched between the wheel hub and a shoulder of an outer joint member, forming a part of a constant velocity universal joint, via a disc shaped expansion compensating members made of heat resisting synthetic resin, and a predetermined preload is applied to the wheel bearing.

14. The bearing apparatus of claim 13 wherein an annular groove is formed on each end face of larger diameter of the inner ring and the annular groove is filled with the expansion compensating member.

15. The bearing apparatus of claim 8, wherein said resin band is formed by injection molding.
